(19) United States
(12) Patent Application Publication
(10) Pub. No.: US 2014/0068155 A1
(43) Pub. Date: Mar. 6, 2014

(54) INFORMATION PROCESSING APPARATUS, INFORMATION PROCESSING METHOD, AND PROGRAM

(71) Applicant: SONY CORPORATION, Tokyo (JP)

(72) Inventors: Takashi NITTA, Tokyo (JP); Takao SHINOHARA, Kanagawa (JP); Tomoyuki ITO, Kanagawa (JP)

(73) Assignee: SONY CORPORATION, Tokyo (JP)

(21) Appl. No.: 13/947,333

(22) Filed: Jul. 22, 2013

(30) Foreign Application Priority Data
Aug. 30, 2012 (JP) 2012190272

(51) Int. Cl. G06F 12/02

(52) U.S. Cl. CPC G06F 12/0246
USPC 711/103

(57) ABSTRACT

Provided is an information processing apparatus, including: a volatile memory; a nonvolatile memory including a rewritable area configured to store rewritable data, and a non-rewritable area configured to store non-rewritable data and a Snapshot Boot image, the Snapshot Boot image showing a home window corresponding to an execution status of the non-rewritable data; and a controller configured to load the rewritable data and the Snapshot Boot image into the volatile memory when booting, and to draw the home window based on difference information and the Snapshot Boot image, the difference information corresponding to difference data of the rewritable data before and after

### BACKGROUND

The present disclosure relates to an information processing apparatus configured to install various applications thereinto and to execute the various applications. The present disclosure further relates to an information processing method and a program of the information processing apparatus.

In the past, there is known Snapshot Boot (SSB). SOB is a technology of increasing the booting speed of an information processing apparatus.

According to this technology, a snapshot image is stored in a nonvolatile memory when an information processing apparatus leaves a factory. The snapshot image corresponds to execution results of initializing process of a kernel, a device driver, application programs, and the like after the information processing apparatus is booted for the first time. Further, when the information processing apparatus is booted, the snapshot image stored in the nonvolatile memory is loaded into a volatile memory. Because of this, the various initializing process and the like, which are executed during the normal booting, are omitted. As a result, the boot time of the information processing apparatus may be shortened. (for example, see Japanese Patent Application Laid-open No. 2010-271980).

### SUMMARY

However, according to the above-mentioned SSB, the same image is loaded as the snapshot image every time the information processing apparatus is booted. Because of this, the following situation may occur. For example, an application is added or the like. The system of the information processing apparatus is thus changed. Even in this case, the changed matter is not reflected in the image. That is, data of a file system of the information processing apparatus is inconsistent with data expanded in a volatile memory.

According to the technology of Japanese Patent Application Laid-open No. 2010-271980, read-only data is booted by using a snapshot image. Processing is executed based on rewritable data data every time the rewritable data is booted.

However, Japanese Patent Application Laid-open No. 2010-271980 fails to describe how to draw an image such as an icon or a snapshot image.

In view of the above-mentioned circumstances, it is desirable to provide an information processing apparatus, an information processing method, and a program, each of which may ensure consistency between data of a file system and image data expanded in a volatile memory in a case of Snapshot Boot.

According to an embodiment of the present technology, there is provided an information processing apparatus, including a volatile memory; a nonvolatile memory including a rewritable area configured to store rewritable data, and a non-rewritable area configured to store non-rewritable data and a Snapshot Boot image, the Snapshot Boot image showing a home window corresponding to an execution status of the non-rewritable data; and a controller configured to load the rewritable data and the Snapshot Boot image into the volatile memory when booting, and to draw the home window based on difference information and the Snapshot Boot image, the difference information corresponding to difference data of the rewritable data before and after the booting.

As a result the information processing apparatus may ensure consistency between data of a file system and image data expanded in a volatile memory in a case of Snapshot Boot.

The rewritable area may be configured to store the rewritable data, the rewritable data being data on an application, the application being installed when booting the information processing apparatus previously. The controller may be configured to draw an icon on the home window, the icon corresponding to the installed application.

As a result, the information processing apparatus may avoid the following trouble. That is, an icon of an application, which is surely installed and added to a home window, is not displayed after booting.

The controller may be configured to execute a command about the home window again, the command being executed in a case where an application is installed when booting the information processing apparatus previously, to thereby draw the icon on the home window.

As a result, the information processing apparatus uses an existing command. The information processing apparatus may thus draw an icon of a newly-installed application smoothly.

The controller may be configured to execute one command corresponding to a plurality of applications in a case where the plurality of applications are installed when booting the information processing apparatus previously, to thereby draw a plurality of icons corresponding to the plurality of applications at a time.

Let's say that many applications are installed when booting the information processing apparatus previously. Even in this case, the information processing apparatus draws a plurality of icons corresponding to the applications at a time based on one command. As a result, the drawing time may be shortened. In addition, the hoot time may be shortened.

The rewritable area may be configured to store the rewritable data, the rewritable data being setting information on a function of the information processing apparatus, the setting information being changed when booting the information processing apparatus previously. The controller may be configured to draw an icon corresponding to the changed setting information on the home window.

Let's say that setting information of various functions of the information processing apparatus is changed. As a result, the status of icons on a home window is changed when booting the information processing apparatus previously. Even in this case, the information processing apparatus may reflect the status of icons in a home window in a case of Snapshot Boot. Examples of setting information include information on network setting, display setting, sound setting, and the like.

The information processing apparatus may further include an external interface configured to connect to an external device. The controller may be configured to draw an icon on the home window, the icon being drawn on the home window in a case where the external interface connects to the external device when booting the information processing apparatus previously.

As a result, the information processing apparatus may prevent the following situation from occurring. That is, the status of connection to an external device is not changed before and after Snapshot Boot. Even in this case, the status of icons on a home window, which corresponds to the connection status, changes.

According no another embodiment of the present technology, there is provided an information processing method, including: loading rewritable data and a Snapshot Boot image from a nonvolatile memory into a volatile memory when booting an information processing apparatus, the nonvolatile memory including a rewritable area and a non-rewritable area, the rewritable area storing the rewritable data, the non-rewritable area storing non-rewritable data and the Snapshot Boot image, the Snapshot Boot image showing a home window corresponding to an execution status of the non-rewritable data; and drawing the home window based on difference information and the Snapshot Boot image, the difference information corresponding to difference data of the rewritable data before and after the booting.

According to another embodiment of the present technology, there is provided a program causing an information processing apparatus to execute the steps of: loading rewritable data and a Snapshot Boot image from a nonvolatile memory into a volatile memory when booting the information processing apparatus, the nonvolatile memory including a rewritable area and a non-rewritable area, the rewritable area storing the rewritable data, the non-rewritable area storing non-rewritable data and the Snapshot Boot image, the Snapshot Boot image showing a home window corresponding to an execution status of the non-rewritable data; and drawing the home window based on difference information and the Snapshot Boot image, the difference information corresponding to difference data of the rewritable data before and after the booting.

As described above, according to the present technology, consistency between data of a file system and image data expanded in a volatile memory may be ensured in a case of Snapshot Boot.

These and other objects, features and advantages of the present disclosure will become more apparent in light of the following detailed description of best mode embodiments thereof, as illustrated in the accompanying drawings.

### BRIEF DESCRIPTION OF DRAWINGS

FIG. 1 is a block diagram showing the hardware configuration of a smartphone according to an embodiment of the present technology;

FIG. 2 is a simplified diagram showing the file system structure of a data file stored in a nonvolatile memory of the smartphone;

FIG. 3 is a diagram showing an outline of the flow of the SSB behavior of the smartphone;

FIG. 4 is a diagram showing the flow of the SSB behavior of the smartphone;

FIG. 5 is a diagram showing statuses of the home window before and after the SSB behavior of the smartphone;

FIG. 6 is a diagram showing the status of the home window before and after the SSB behavior of the smartphone in a case where a plurality of applications are installed; and

FIG. 7 is a diagram showing the flow of draw processing of icons of the plurality of applications of FIG. 6.

### DETAILED DESCRIPTION OF EMBODIMENTS

Hereinafter, an embodiment of the present disclosure will be described with reference to the drawings. The present disclosure is applied to a smartphone.

### [Hardware Configuration of Smartphone]

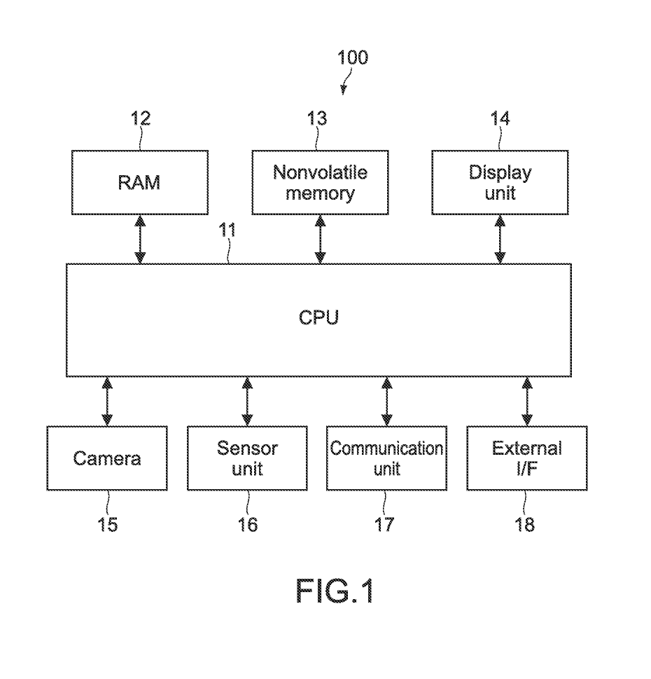

FIG. 1 is a diagram showing the hardware configuration of a smartphone 100.

As shown in FIG. 1, the smartphone 100 includes a CPU (Central Processing Unit) 11, a RAM (Random Access Memory) 12, a nonvolatile memory 13, a display unit 14, a camera 15, a sensor unit 16, a communication unit 17, and an external interface (I/F) 18.

The CPU 11 accesses the RAM 12 and the like as necessary. The CPU 11 executes various arithmetic processing, and controls the overall blocks of the smartphone 100.

The RAM 12 is, for example, used as a work area of the CPU 11. The RAM 12 temporarily stores an OS, various applications being executed, and various data being processed. Specifically, according to this embodiment, in Snapshot Boot (hereinafter referred to as SSB) processing (described later), an SSB image stored in the nonvolatile memory 13 is expanded in the RAM 12.

The nonvolatile memory 13 is, for example, a flash memory or a ROM (Read Only Memory). The nonvolatile memory 13 is a fixed memory, and stores firmware executed by the CPU 11. Examples of the firmware include the OS, programs (applications), various parameters, and the like. For example, Android (registered trademark) is installed as the OS.

Specifically, according to this embodiment, the nonvolatile memory 13 stores an SSB image. The SSB image is necessary for Snapshot Boot processing (described later). The SSB image shows a home window. The home window corresponds to execution results of initializing process of a kernel, a device driver, application programs, and the like after the smartphone is booted for the first time. The SSB image is stored in the nonvolatile memory 13 when the smartphone leaves a factory.

The display unit 14 is, for example, an LCD (Liquid Crystal Display) or an DELL) (Organic ElectroLuminescence Display). For example, the display unit 14 displays various menus including a plurality of icons, GUIs of an application being executed, and the like. The display unit 14 includes a built-in touchscreen, and is capable of receiving touch operations input by a user.

The camera 15 includes an image sensor such as, for example, a CMOS (Complementary Metal Oxide Semiconductor) or a CCD (Charge Coupled Devices) sensor. The camera 15 takes still images (photographs) and moving images.

The sensor unit 16 includes various sensors. The sensor unit 16 detects location information (latitude/longitude information), orientation information, physical information (acceleration/gravity information), and the like of the smartphone 100.

The communication unit 17 connects to a network such as a wireless LAN (IEEE 802.11, etc.) such as WiFi (Wireless Fidelity). Alternatively, the communication unit 17 connects to a mobile communication network for 3G, LET (Long Term Evolution), or 4G. The communication unit 17 communicates with other devices.

The external interface 18 is used to connect an external device to the smartphone 100. For example, the external interface 18 is a sound input/output terminal, a USE (Universal Serial Bus) terminal, or the like. The external device is any one of various devices including a keyboard, a headphone, an earphone, a speaker, a microphone, a car navigation system, a charger, a transmitter, a media player, a PC, a printer, and the like, for example.

### [File System Structure]

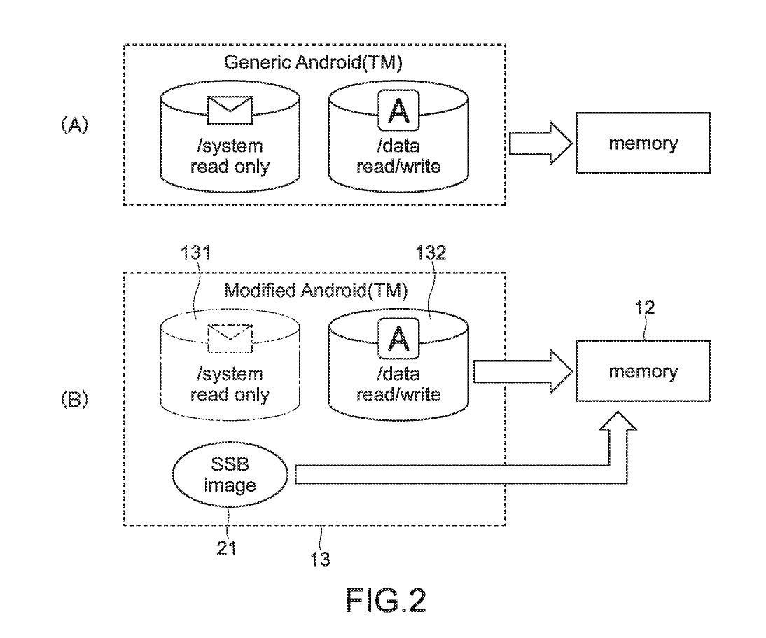

FIG. 2 is a simplified diagram showing the file system structure of a data file stored in the nonvolatile memory 13. In FIG. 2, the file system structure is compared to an existing system.

The upper part (A) of FIG. 2 shows the file system structure of an existing Android (registered trademark) terminal. The lower part (B) of FIG. 2 shows the file system structure of the nonvolatile memory 13 of the smartphone 100 of this embodiment.

As shown in FIG. 2, the file system of the nonvolatile memory 13 includes a system directory 131 and a data directory 132 below a root directory. The system directory 131 is a non-rewritable area, in which non-rewritable data is stored. The data directory 132 is a rewritable area, in which rewritable data is stored.

Examples of non-rewritable data stored in the system directory 131 include applications (services) preinstalled in the smartphone 100. Further, the system directory 131 also stores the SSB image.

Examples of rewritable data stored in the data directory 132 include applications, which the smartphone 100 downloads from services (application stores) in a cloud via the communication unit 17 and the like, and installs. Such an application is supplied in a form of file (package) including an extension “apk”, for example. Further, setting information of functions of the smartphone 100 is also stored in the data directory 132 as rewritable data. Examples of such setting information include window (desktop) setting, network setting, sound setting, and the like.

As shown in (A) of FIG. 2, when the existing Android (registered trademark) system is booted, both data of the system directory and data of the data directory are read in a RAM.

Meanwhile, as shown in (B) of FIG. 2, when the smartphone 100 of this embodiment is booted, rewritable data of the data directory 132 is read in the RAM 12. However, non-rewritable data of the system directory 131 is not read in the RAM 12. Instead, an SSB image 21 is read in the RAM 12.

### [Behaviors of System]

Next, behaviors of the smartphone 100 of the system structured as described above will be described. According to this embodiment, the CPU 11 and software modules, which are controlled by the CPU 11, cooperatively execute behaviors of the smartphone 100.

### (Outline of Behaviors of SSB)

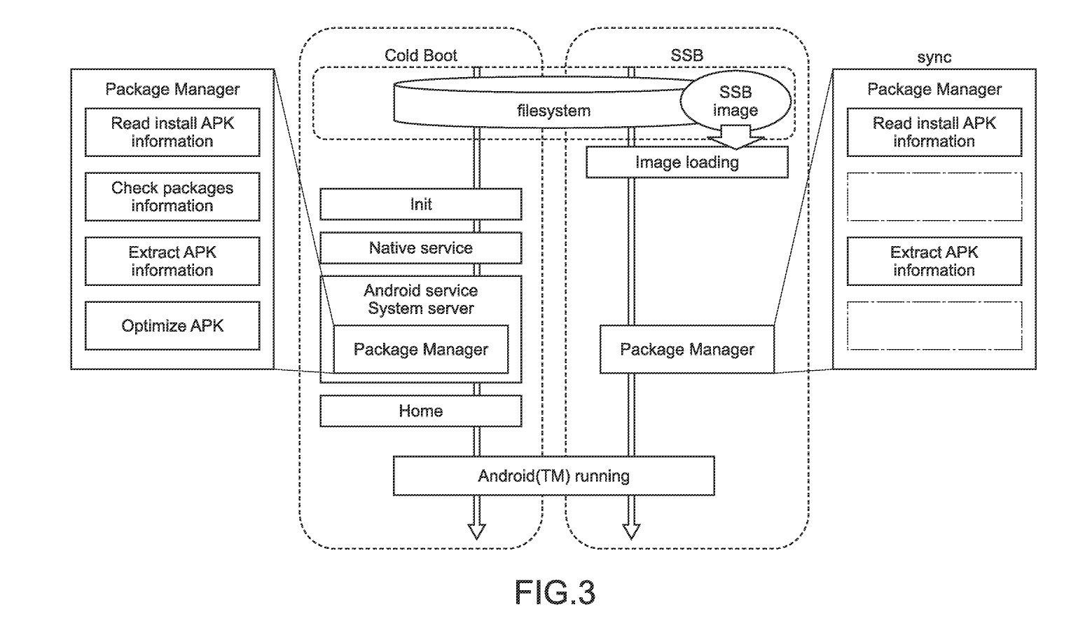

FIG. 3 is a diagram showing an outline of the flow of the SSB behavior of the smartphone 100. In FIG. 3, the flow of the SSB behavior of the smartphone 100 is compared to the boot (Cold Boot) behavior of an existing Android (registered trademark) terminal.

As shown in the left part of FIG. 3, Init boot processing, Native Service boot processing, System Server and Android (registered trademark) Service boot processing, and Home boot processing are executed in series, according to the Cold Boot processing. After that, Android (registered trademark) is executed.

Each of loin boot processing and Native Service boot processing relates to programs, which are stored in the non-rewritable system directory 131. Further, according to Home boot processing, an application called launcher boots a home window based on the previous boot processing.

Further, according to System Server boot processing, Package Manager is also booted. Package Manager is a framework, which manages and boots packages (APK files) installed in the system directory 131 and the data directory 132.

Specifically, for example, Package Manager reads information on the packages (APK files), which were installed, before booting, during Cold Boot. Package Manager confirms information on all the installed packages. Package Manager expands the APK files an the RAM. Package Manager optimizes the APK files.

Meanwhile, as shown in the right part of FIG. 3, according to this embodiment, the above-mentioned ant boot processing, Native Service boot processing, and Home boot processing are omitted. Instead, the SSB image 21 is expanded in the RAM 12.

Further, in the package boot processing executed by Package Manager, only minimum processing is executed out of the processing executed in the existing Cold Boot processing. As a result, data of the file system is in sync with data of the RAM 12. That is, Package Manager of this embodiment only reads information on packages newly installed in the rewritable data directory 132, and expands the packages in the RAM 12. Package Manager of this embodiment does not obtain and optimize information on packages preinstalled in the non-rewritable system directory 131.

### (Detailed Flow of SSB Behavior)

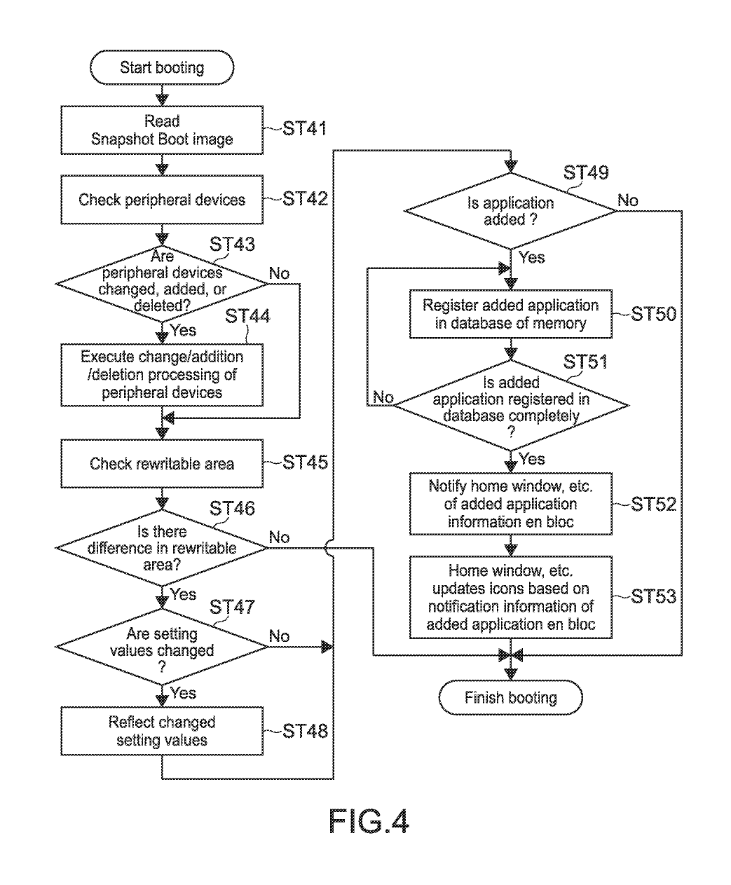

FIG. 4 is a flowchart showing a more specific flow of SSB behavior of the smartphone.

As shown in FIG. 4, the smartphone 100 is turned on in SSB. Then, first, the CPU 11 reads the SSB image 21 of the system directory 131 in the RAM 12 (Step 41).

Next, the CPU 11 compares the present peripheral device status to the initial status. The CPU 11 determines if peripheral devices, which are connected to the external interface 18, are changed, added, or deleted or not (Step 42).

The CPU 11 determines that peripheral devices are changed, added, or deleted (Step 43, Yes). In this case, the CPU 11 draws/deletes icon and other images on/from the SSB image 21 in response to the change, addition, or deletion of the peripheral, devices (Step 44). For example, the CPU 11 detects that a keyboard is connected to the external interface 18. In this case, the CPU 11 reflects an icon, which shows connection of the keyboard, in the SSB image 21. The CPU 11 thus draws the home window.

Next, the CPU 11 confirms information on the data directory 132, i.e., the rewritable area (Step 45).

As the result of the confirmation, the CPU 11 determines that there is a difference between information on the data directory 132 and information on the initial status of the data directory 132 (Step 46, Yes). In this case, the CPU 11 determines if the difference relates to change of setting values of functions of the smartphone 100 or not (Step 47).

The CPU 11 determines that the difference relates to change of setting values (Step 47, Yes). In this case, the CPU 11 reflects the changed setting values in images (for example, icon, desktop, etc.) of the SSB image 21. As a result, the CPU 11 updates the home window (Step 48).

In Step 47, the CPU 11 determines that the difference does not relate to change of setting values (No). In this case, the CPU 11 determines if the difference relates to additional install of an application when the smartphone 100 is booted before or not (Step 49).

The CPU 11 determines that the difference relates to addition of an application (Yes). In this case, the CPU 11 registers information on the added application in database of the RAM 12 (Step 50). Examples of information on the application include various kinds of management information, i.e., metadata such as an application name, information on a window (activity) necessary to boot, finish, and execute an application, and the like. Information on an image out of the registered information is reflected in the SSB image 21. Examples of the information on an image include an application name (which is displayed together with and the like. The information on an image is used to draw the home window. Meanwhile, information, which does not relate to an image, out of the registered information is stored in the RAM 12. However, the information is not drawn on the home window.

The added application information is registered completely (Step 51, Yes). In this case, the CPU 11 notifies a launcher of the added application information by using a command. The launcher is configured to boot the home window (Step 52).

The command is the same as the command, which the CPU 11 notifies the launcher of when an application is newly installed after the previous SSB of the smartphone 100. That is, the CPU 11 executes the command, which is the same as the command executed when an application is added after the previous SSB, again in the next SSB.

Let's say that there are a plurality of added applications at this time. In this case, the CPU 11 notifies information on the plurality of applications by using one command en bloc.

Further, based on the added application information, the launcher reads out image data such as icon data corresponding to the added application information, in response to the notification. The launcher reflects the image data in the SSB image 21. As a result, the launcher updates the home window. The launcher displays the home window on the display unit 14 (Step 53). That is, the launcher determines that a new application is added based on the notification. The launcher newly draws the icon of the application on the home window similar to the case where an application is added after the smartphone 100 is booted.

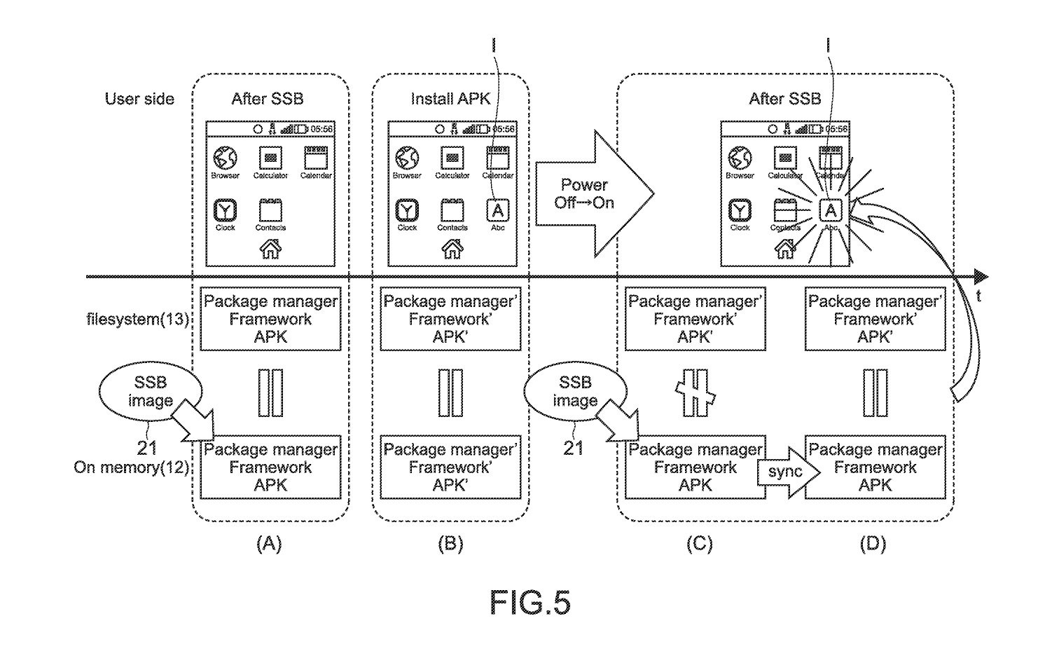

FIG. 5 is a diagram showing statuses of the home window before and after the SSB behavior.

As shown in (A) and (B) of FIG. 5, one application is installed in the previous SSB. In this case, an icon I, which corresponds to the application, is added to the home window. At this time, the data status of the file system of the nonvolatile memory 13 is the same as the data status of the RAM 12.

After that, the smartphone 100 is turned off, and then turned on again. SSB is executed again. In this case, as shown in (C) of FIG. 5, the application added in the previous SSB is not reflected in the SSB image 21 read in the RAM 12. That is, at this time, the data status of the file system of the nonvolatile memory 13 is inconsistency with the data status of the RAM 12.

Meanwhile, as shown in (D) of FIG. 5, the icon I corresponding to the added application is reflected in the SSB image 21, and the home window is thus displayed. Because of this, the status of the RAM 12 may be in sync with the status of the file system. As a result, inconsistency between the status of the RAM 12 and the status of the file system may be canceled.

(Processing in Case where Plurality of Applications are Installed Before Booting)

Hereinafter, how to update the home window in a case where the plurality of applications are installed will be described in detail.

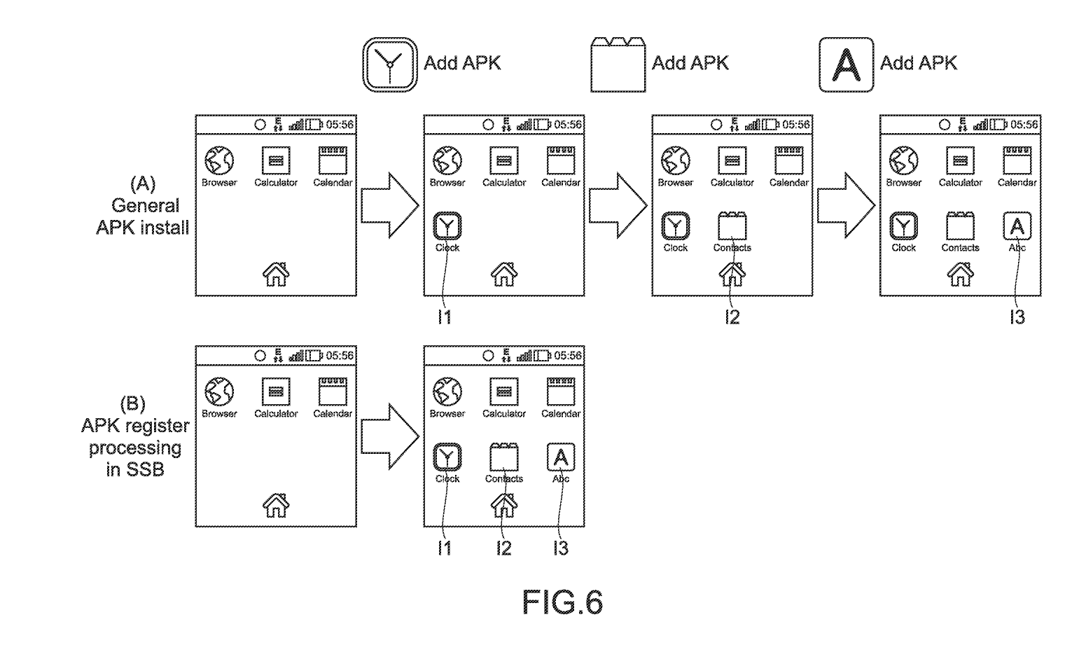

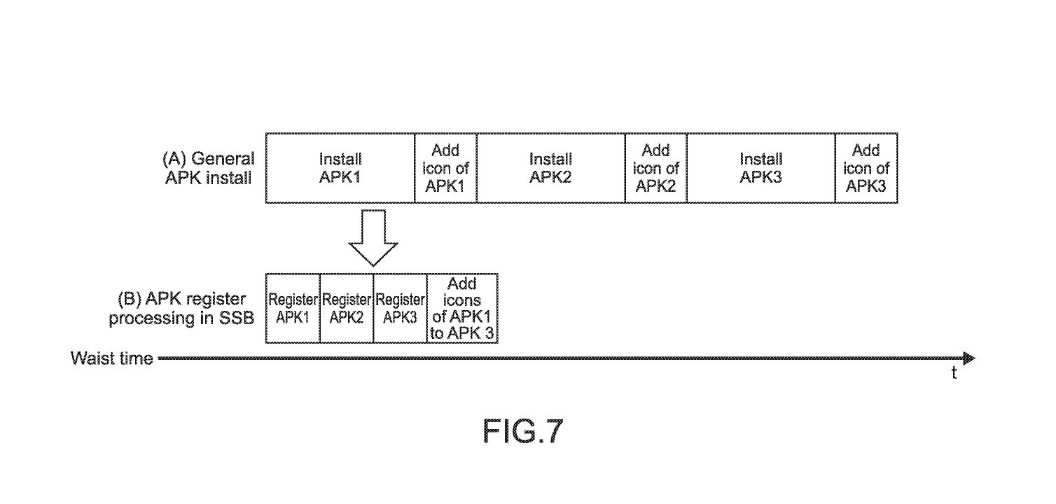

FIG. 6 is a diagram showing the status of the home window before and after the SSB behavior in a case where a plurality of applications are installed. In FIG. 6, the state of the home window is compared to application install processing of an existing Android (registered trademark) system. Further, FIG. 7 is a diagram showing the flow of draw processing of icons of the plurality of applications of FIG. 6. In FIG. 7, the draw processing is compared to the application install processing of the existing Android (registered trademark) system.

(A) of FIG. 6 shows the status of the home window when a plurality of applications are added to an existing Android (registered trademark) system. Further, (A) of FIG. 7 shows the flow of how to draw icons on the home window, and corresponds to (A) of FIG. 6.

(B) of FIG. 6 shows the following status of the home window of this embodiment. A plurality of applications are added to the smartphone 100 in the previous SSB. After that, SSB is executed again. (B) of FIG. 7 shows the flow of how to draw icons of a plurality of applications in SSB of this embodiment, and corresponds to (B) of FIG. 6.

As shown in FIG. 6 and FIG. 7, according to the existing Android (registered trademark) system, when a plurality of applications are installed, install processing is executed for each application. The icons (I1, I2, I3) are added to the home window in order every time each application is installed.

Meanwhile, in SSB of this embodiment, as described above, the CPU 11 notifies the launcher of information on applications, which are added in the previous SSB, en bloc. The icons I1, I2, and I3 are drawn on the home window at a time based on the notification.

Let's say that a plurality of applications are added in the previous SSB. Even in this case, according to this embodiment, a time period required to draw icons of the application in SSB after that is thus shortened. In addition, a time period required for SSB processing is shortened.

As described above, according to this embodiment, difference information is reflected in an SSB image depending on a difference between data of file system and an SSB image before and after SSB. An image such as an icon is thus drawn on the home window. As a result, inconsistency between data of file system and an SSB image may be prevented from occurring. Further, even in this case, only minimum processing necessary to extract the difference is executed. As a result, high-speed boot is realized.

### [Modifications]

It should be understood by those skilled in the art that various modifications, combinations, sub-combinations and alterations may occur depending on design requirements and other factors insofar as they are within the scope of the appended claims or the equivalents thereof.

### (Modification 1)

In the above embodiment, the processing flow of the flowchart of FIG. 4 is merely an example. The order of each processing of the flowchart may be changed as necessary.

### (Modification 2)

In the example of the above embodiment, the present technology is applied to an information processing apparatus (smartphone), in which Android (registered trademark) is installed as an OS. Alternatively, an OS other than Android (registered trademark) may be installed in the information processing apparatus of the present technology. In this case, the processing of this embodiment may be changed as necessary depending on the spec of the OS.

### (Modification 3)

In the example of the above embodiment, the present technology is applied to a smartphone. Alternatively, the present technology may also be applied to any information processing apparatus such as a digital still camera, a camcorder, a tablet. PC (Personal Computer), a desktop PC, a laptop PC, a. PDA (Personal Digital Assistant), a mobile AV player, an electronic book reader, a television receiver, a PVR (Personal Video Rec order), a game machine, a projector, a car navigation system, a digital photo frame, or an HDD (Hard Disk Drive) device.

### [Supplementary Note]

The present technology may adopt the following configurations.
(1) An information processing apparatus, comprising:

a volatile memory;

a nonvolatile memory including
a rewritable area configured to store rewritable data, and
a non-rewritable area configured to store non-rewritable data and a Snapshot Boot image, the Snapshot Boot image showing a home window corresponding to an execution status of the non-rewritable data; and

a controller configured
to load the rewritable data and the Snapshot Boot image into the volatile memory when booting, and
to draw the home window based on difference information and the Snapshot Boot image, the difference information corresponding to difference data of the rewritable data before and after the booting.
(2) The information processing apparatus according to (1), wherein

the rewritable area is configured to store the rewritable data, the rewritable data being data on an application, the application being installed when booting the information processing apparatus previously, and

the controller is configured to draw an icon on the home window, the icon corresponding to the installed application.
(3) The information processing apparatus according to (2), wherein

the controller is configured to execute a command about the home window again, the command being executed in a case where an application is installed when booting the information processing apparatus previously, to thereby draw the icon on the home window.
(4) The information processing apparatus according to (2) or (3), wherein

the controller is configured to execute one command corresponding to a plurality of applications in a case where the plurality of applications are installed when booting the information processing apparatus previously, to thereby draw a plurality of icons corresponding to the plurality of applications at a time.
(5) The information processing apparatus according to any one of (2) to (4), wherein

the rewritable area is configured to store the rewritable data, the rewritable data being setting information on a function of the information processing apparatus, the setting information being changed when booting the information processing apparatus previously, and

the controller is configured to draw an icon corresponding to the changed setting information on the home window.
(6) The information processing apparatus according to any one of (2) to (5), further comprising:

an external interface configured to connect to an external device, wherein

the controller is configured to draw an icon on the home window, the icon being drawn on the home window in a case where the external interface connects to the external device when booting the information processing apparatus previously.

The present disclosure contains subject matter related to that disclosed in Japanese Priority Patent Application. JP 2012-190272 filed in the Japan Patent Office on Aug. 30, 2012, the entire content of which is hereby incorporated by reference.

What is claimed is:

1. An information processing apparatus, comprising:
a volatile memory;
a nonvolatile memory including
a rewritable area configured to store rewritable data, and
a non-rewritable area configured to store non-rewritable data and a Snapshot Boot image, the Snapshot Boot image showing a home window corresponding to an execution status of the non-rewritable data; and
a controller configured
to load the rewritable data and the. Snapshot Boot image into the volatile, memory when booting, and
to draw the home window based on difference information and the Snapshot Boot image, the difference information corresponding to difference data of the rewritable data before and after the booting.

2. The information processing apparatus according to claim 1, wherein
the rewritable area is configured to store the rewritable data, the rewritable data being data on an application, the application being installed when booting the information processing apparatus previously, and
the controller is configured to draw an icon on the home window, the icon corresponding to the installed application.

3. The information processing apparatus according to claim 2, wherein
the controller is configured to execute a command about the home window again, the command being executed in a case where an application is installed when booting the information processing apparatus previously, to thereby draw the icon on the home window.

4. The information processing apparatus according to claim 3, wherein
the controller is configured to execute one command corresponding to a plurality of applications in a case where toe plurality of applications are installed when booting the information processing apparatus previously, to thereby draw a plurality of icons corresponding to the plurality of applications at a time.

5. The information processing apparatus according to claim 2, wherein
the rewritable area is configured to store the rewritable data, the rewritable data being setting information on a function of the information processing apparatus, the setting information being changed when booting the information processing apparatus previously, and
the controller is configured to draw an icon corresponding to the changed setting information on the home window.

6. The information processing apparatus according to claim 2, further comprising:
an external interface configured to connect to an external device, wherein
the controller is configured to draw an icon on the home window, the icon being drawn on the home window in a case where the external interface connects to the external device when booting the information processing apparatus previously.

7. An information processing method, comprising:
loading rewritable data and a Snapshot Boot image from a nonvolatile memory into a volatile memory when booting an information processing apparatus, the nonvolatile memory including a rewritable area and a non-rewritable area, the rewritable area storing the rewritable data, the non-rewritable area storing non-rewritable data and the Snapshot Boot image, the Snapshot Boot image showing a home window corresponding to an execution status of the non-rewritable data; and
drawing the home window based on difference information and the Snapshot Boot image, the difference information corresponding to difference data of the rewritable data before and after the booting.

8. A program causing an information processing apparatus to execute the steps of:
loading rewritable data and a Snapshot Boot image from a nonvolatile memory into a volatile memory when booting the information processing apparatus, the nonvolatile memory including a rewritable area and a non-rewritable area, the rewritable area storing the rewritable data, the non-rewritable area storing non-rewritable data and the Snapshot Boot image, the Snapshot Boot image showing a home window corresponding to an execution status of the non-rewritable data; and
drawing the home window based on difference information and the Snapshot Boot image, the difference information corresponding to difference data of the rewritable data before and after the booting.
